(19) United States
(12) Patent Application Publication
(10) Pub. No.: US 2004/0120589 A1
(43) Pub. Date: Jun. 24, 2004

(54) Method and apparatus for providing resource-optimized delivery of web images to resource-constrained devices

(76) Inventors: Daniel Philip Lopresti, Hopewell, NJ (US); Yunnan Wu, Princeton, NJ (US)

Correspondence Address: Docket Administrator ( Room 3J-219), Lucent Technologies Inc., 101 Crawfords Corner Road, Holmdel, NJ, 07733-3030, US

(21) Appl. No.: 10/322,328

(22) Filed: Dec. 18, 2002

(51) Int. Cl. G06K 9/36; G06K 9/34

(52) U.S. Cl. 382/239; 382/176

(57) ABSTRACT

A method and apparatus in which regions of a web image containing textual information (text-containing regions) and regions of the image not containing textual information (non-text-containing regions) are identified and differentially transcoded so as to provide an image quality for the text-containing regions which is superior to (i.e., less degraded relative to) the image quality of the non-text-containing regions. A data structure is generated based on the web image, the data structure containing at least one coded representation for each of the text-containing regions and a plurality of coded representations of each of the non-text-coniaining regions. A coding of the web image is generated from the data structure by selecting coded representations based on characteristics of a particular target client device and the bandwidth of a communications channel. Various coded representations may be generated by down-sampling the given region, or reducing the color depth or number of gray levels thereof.

### FIELD OF THE INVENTION

The present invention relates generally to the field of Internet web page images and in particular to the efficient delivery and display of such images for use with resource-constrained (e.g., hand-held) devices.

### BACKGROUND OF THE INVENTION

The need for ubiquitous information access is expanding at a dramatic rate, as reflected, for example, in the growing popularity of portable hand-held devices such as PDA's (Personal Digital Assistants). Delivering web content to these “thin” clients involves many technical challenges, since these devices are typically constrained in a number of various resources, including (1) screen size and resolution, (2) color depth, (3) computing power, (4) memory and storage, and (5) bandwidth. Although some service providers customize web pages specifically for such hand-held devices, such an approach is costly and does not scale well, given the enormous number of existing web pages designed for traditional displays and the increasing diversity of client devices.

One possible alternative that has been considered is to transcode the web images found on existing web pages for a particular class of client devices. (As is well known to those skilled in the art, “transcoding” a coded image refers to the process of transforming it by re-encoding it with different characteristics such as, for example, a different resolution, color depth or gray scale). Such transcoding may, for example, be performed at source servers, proxies, or even at the clients themselves. In this manner, client devices with limited capabilities can (at least in theory) make optimal use of (e.g., receive and display) web pages which were originally designed with full-capability devices in mind.

### SUMMARY OF THE INVENTION

We have recognized that, given limited bandwidth and display sizes, the text portions of a web image are likely to be the most valuable portion for browsing. As such, we have realized that any attempt to provide efficient delivery and useful display of web images to resource-constrained devices should do so with an emphasis on preserving and presenting the embedded text information, even if it must be at the expense of other portions of the image.

As such, in accordance with the principles of the present invention and certain illustrative embodiments thereof, a method and apparatus for providing resource-optimized delivery of web images to resource-constrained devices is provided in which regions of the image containing textual information (text-containing regions) and regions of the image not containing textual information (non-text-containing regions) are each identified, and then, differential transcoding is performed on each of these regions so as to provide an image quality for the text-containing regions which is better than (i.e., less degraded relative to) the image quality of the non-text-containing regions.

In accordance with one illustrative embodiment of the present invention, a data structure is advantageously generated based on the web image, the data structure containing at least one coded representation for each of the text-containing regions and a plurality of coded representations of each of the non-text-containing regions. Then, based on certain characteristics of the client device, a coding of the web image is generated from the data structure by selecting coded representations so as to provide an image quality for the text-containing regions which is superior to (i.e., less degraded than) the image quality of the non-text-containing regions. Illustratively, various relevant characteristics of the client device include display resolution, color depth and a number of gray levels, and various coded representations may be generated by, for example, down-sampling the given region, or reducing the color depth or number of gray levels thereof. In addition, and in accordance with one illustrative embodiment of the present invention, a server containing the aforementioned data structure in a memory therein generates the coding of the web image further based on characteristics of the communications channel, such as, for example, the bandwidth thereof.

### BRIEF DESCRIPTION OF THE DRAWINGS

FIG. 1 shows an illustrative image analysis and compression performed on a sample web image in accordance with one illustrative embodiment of the present invention.

FIG. 2 shows an illustrative content adaptation process invoked on a sample web image in accordance with one illustrative embodiment of the present invention.

FIG. 3 shows an illustrative view of a sample web page as displayed on an illustrative small-screen device in accordance with one illustrative embodiment of the present invention.

FIG. 4 shows an illustrative data structure representative of a web image in accordance with one illustrative embodiment of the present invention.

### DETAILED DESCRIPTION

Introduction

Web images fall into two categories—natural images (such as photographs), and synthetic images (such as graphics). This dichotomy is reflected in different approaches typically used for compression.

Natural images are characterized by their richness in color (typically 24-bit true color) and the smooth transitions between pixels. Prevailing compression algorithms such as, for example, JPEG and JPEG2000, each fully familiar to those of ordinary skill in the art), are composed of the following steps—transformation of the image pixel data into the frequency domain, quantization of the resultant transformed data (i.e., coefficients), and lossless coding of the quantized coefficients. For example, JPEG, the state-of-the-art compression standard for natural images, adopts a 8×8 block-based DCT (Discrete Cosine Transform) transform coding framework. The upcoming image compression standard, JPEG2000, is based on a wavelet transformation.

Synthetic images, on the other hand, which are usually created using graphics software, have as their typical defining characteristics a limited number of colors and an abundance of sharp edges. Representative compression schemes for synthetic images are GIF and PNG (each of which is fully familiar to those of ordinary skill in the art), both based on a lossless Lempel-Ziv compression of the image in a one-dimensional raster scan format. (Lempel-Ziv compression is a lossless compression technique fully familiar to those of ordinary skill in the art.)

Whether an image is natural or synthetic, it may contain overlaid text. On a resource-constrained device (e.g., a PDA, or Personal Digital Assistant), the text is often what the user is most interested in. From the standpoint of such resource-constrained devices, synthetic images are more germane because they tend to be smaller and usually require fewer colors. Consequently, in accordance with certain illustrative embodiments of the present invention described in detail herein, we will focus on transcoding synthetic images, advantageously preserving the textual content while simplifying other portions of the image.

An Illustrative System Architecture According to One Embodiment of the Invention

In accordance with certain illustrative embodiments of the present invention, an adaptive delivery system is advantageously comprised of three components—image analysis and compression, content adaptation, and flexible display. Illustrative embodiments of each of these components will be described in detail below.

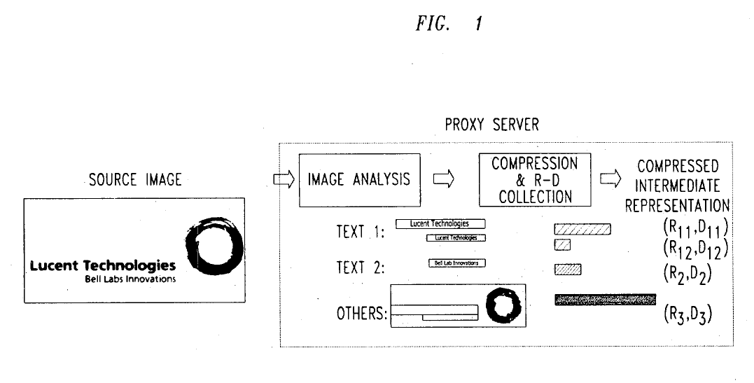

FIG. 1 shows an illustrative image analysis and compression performed on a web image in accordance with one illustrative embodiment of the present invention. In particular, as can be seen in the figure, an input image is first analyzed at a proxy server in order to identify rectangular bounding boxes around text regions. Color reduction and down-sampling are then advantageously applied to each image region to form approximations for lower-quality rendering. After that, the approximations are advantageously compressed and their rate-distortion information is collected.

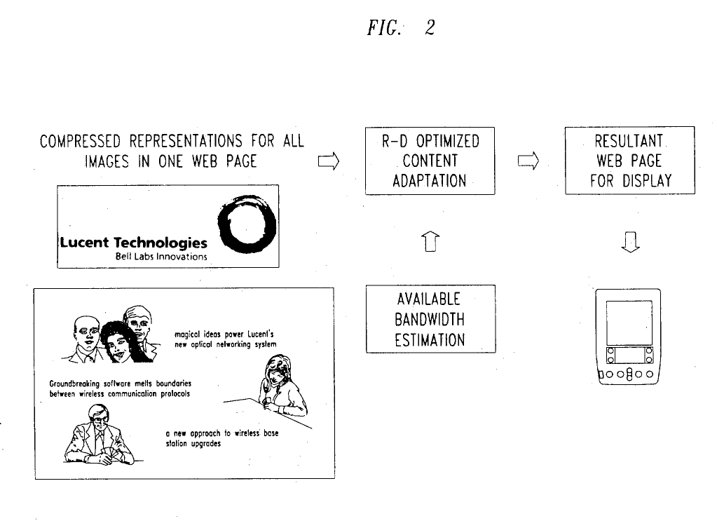

FIG. 2 shows an illustrative content adaptation process invoked on a sample web image in accordance with one illustrative embodiment of the present invention. Illustratively, each time a web page is accessed, this content adaptation process may be invoked to allocate the resources among the images and to transcode them, as shown in the figure. This optimization relies on an external module to supply data on the available bandwidth.

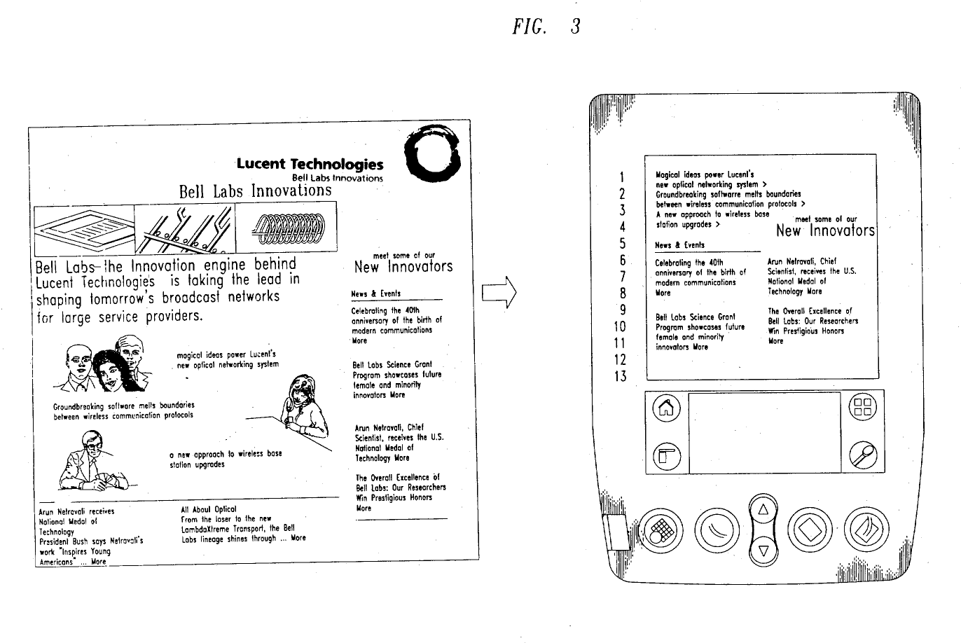

FIG. 3 shows an illustrative view of a sample web page as displayed on an illustrative small-screen device in accordance with one illustrative embodiment of the present invention. In one embodiment, the decoder and rendering system advantageously interacts with the user and thereby customizes the display at the client device. The figure shows an example web page and what an adapted version might look like on a PDA. Note that in this particular case, all of the non-text graphics have been discarded and the page layout has been re-organized. Since the large image in the upper-left corner of the original web page has no hypertext link associated with it, the user may, for example, click on it to remove it from the current window, as can be seen in the adapted view in the figure.

Image Analysis and Compression in an Illustrative Embodiment of the Invention

The essential goal of image analysis and compression is to develop a spectrum of approximations of the original image which require less bits and have fewer colors and/or coarser resolutions. In addition, the rate-distortion tradeoffs of the different approximations may be quantified for later optimal resource allocation.

The objective of content-level image analysis in particular is to extract structural information from a given structure-less image. This problem can be viewed as the inverse of image authoring/composition. During the authoring stage, most graphics software maintains a collection of independent objects and their respective shapes, textures, locations, and layers. In content-level image analysis, we wish to decompose the image into “objects” corresponding to semantically meaningful entities. One such example used in accordance with the principles of the present invention is text regions, which may, for example, be defined by rectangular bounding boxes.

Traditionally, such document image analysis has been motivated by recognition tasks such as, for example, optical character recognition (OCR). Although encoded text is indeed a compact representation for the information contained in an image, full recognition is computationally demanding. Moreover, OCR errors may jeopardize a user's perception. Web images are particularly difficult as they typically employ lower spatial resolutions than scanned documents.

In contrast, the content-level image analysis pursued in accordance with the principles of the present invention is driven by compression and delivery needs. Rather than attempt to recognize the text for the user, we simplify the image while preserving the text regions (and thereby leaving text recognition to the user). This difference allows us to make use of conventional pre-processing methods for text localization (previously used, for example, in OCR applications), without having to employ later-stage (and more problematic) techniques like character segmentation. Thus, in accordance with various illustrative embodiments of the present invention, any of a number of conventional algorithms for text localization, each of which will be fully familiar to those of ordinary skill in the art, may be advantageously employed to identify one or more text-containing regions in a web image.

In our goal of constructing image approximations, image analysis is broad in its meaning—it includes low-level image analysis as well as transformations. Low-level image analysis and transformation refers to the construction of approximations via only low-level features such as color, pixel depth, etc. In this aspect, the well-known JPEG2000 standard compression technique achieves scalability by low-level image transformation. In accordance with certain illustrative embodiments of the present invention, either or both of two categories of approximations may be advantageously employed—color reduction (including gray scale reduction) and down-sampling.

Note that approximation techniques are typically associated with a quality measure. Unfortunately, most existing quality measures are based solely on pixel-by-pixel differences and thus may not be indicative of human perception. One general rule of thumb, however, can be stated as follows—a lower-quality image tries to approximate its original by maintaining color and spatial features. For a text region, preserving the strokes and edges is more important than keeping the pixel colors precise. Based on this observation, one illustrative embodiment of the present invention makes use of a quality measure that advantageously combines color and spatial feature distance, as follows.

Specifically, in accordance with the illustrative embodiment of the present invention, let the original image be A and the approximation thereof be B. Given a set of N feature definitions, both images may be advantageously represented as a collection of feature vectors

$${{a}_{m}}^{v} ≡ {( {a}_{m1} , {a}_{m2} , K , {a}_{mN} )}^{T} ,$$

m=1,K,M and

$${{b}_{m}}^{v} ≡ {( {b}_{m1} , {b}_{m2} , K , {b}_{mN} )}^{T} ,$$

m=1,K,M, where M can be less than or equal to the number of pixels in the image, depending on whether or not the feature vector is computed over a subset of pixel positions. We then measure the distance between two images as the distance in the feature vector space:

$${FD ( A , B )}^{2} ≡ {\sum }_{m = 1}^{M} {‖ {{a}_{m}}^{v} - {{b}_{m}}^{v} ‖}^{2} . \qquad ( 1 )$$

Note that the above definition is flexible. For example, linear transformations among the feature components may be used, and the vector distance can be flexibly chosen as the 1-norm, 2-norm, etc. Typically, we assume features are defined by linear filtering results within a local window, such as, for example, by edge detection operators.

As illustrative examples of feature definitions, and in accordance with the illustrative embodiment of the present invention, four features are adopted for each color component (R, G, B), each being a two dimensional linear filter on a 3×3 window:

$$\begin{matrix}{F}_{0} ≡ [ \begin{matrix}0 & 0 & 0 \\ 0 & 1 & 0 \\ 0 & 0 & 0\end{matrix} ] , & {F}_{1} ≡ \frac{1}{2} [ \begin{matrix}1 & 2 & 1 \\ 0 & 0 & 0 \\ - 1 & - 2 & - 1\end{matrix} ] , \\ {F}_{2} ≡ \frac{1}{2} [ \begin{matrix}- 1 & 0 & 1 \\ - 2 & 0 & 2 \\ - 1 & 0 & 1\end{matrix} ] , & {F}_{0} ≡ \frac{1}{3} [ \begin{matrix}1 & 1 & 1 \\ 1 & 8 & 1 \\ 1 & 1 & 1\end{matrix} ] .\end{matrix} \qquad ( 2 )$$

The first feature, F₀, is just the pixel intensity at the center. The second and third features, F₁ and F₂, are the horizontal and vertical Sobel edge detectors, respectively, which approximate the first derivatives of the image. (Sobel edge detectors are fully familiar to those of ordinary skill in the art.) The last feature, F₃, is the Laplace operator (also fully familiar to those of ordinary skill in the art), which approximates the second derivative of the image. Their weightings as given above in Equation (2) are merely illustrative, and were selected through empirical evaluation.

One way to approximate an image is to reduce the number of colors it uses. If the feature definitions are the (R, G, B) components, this is simply an unsupervised clustering problem, whose solution is well known to those skilled in the art. Therefore, conventional techniques such as, for example, “k-means” can be applied. In order to bring spatial features into consideration, we advantageously adopt more general feature definitions and the cost function defined by Equation (1) above. In accordance with one illustrative embodiment of the present invention, the three color components are included among the feature elements.

In accordance with the illustrative embodiment of the present invention, the following color-reduction algorithm is advantageously employed to reduce the colors in the feature space. Given a target number of colors in the output image, the algorithm operates iteratively by alternating between updating the color association of each pixel and updating the assignment of color palettes. (Note that it is guaranteed to converge since each step can only reduce the cost function.) By assuming 2D linear shift-invariant filters with finite support (e.g., a 3×3 window), the algorithm can be implemented efficiently with pipelining and by using the linear superposition of impulse responses, all of which will be familiar to those skilled in the art. The illustrative algorithm, expressed in conventional pseudocode, operates as follows:

1. Initialize the color assignment and association with the result of color reduction based on color space only.

2. repeat

/* Sequentially update the color association. */
for each pixel position do

Given the up-to-date color assignment of all other pixels,
choose the optimal color from the current palette which
minimizes the summed distance of all the feature vectors
which are affected by the current pixel.

end for
/* Sequentially update the color assignment. */
for each color cluster

Consider the color assignment by averaging all the pixels
using the same color association.
if this average operation reduces the distortion measure then

Adopt the new color assignment.

else

Retain the old color assignment.

end if

end for

until the feature domain distortion cannot be reduced further.

Image down-sampling is another well-known approximation for which many algorithms exist. For text bounding boxes, a suitable down-sampling ratio can be selected with heuristic knowledge of legible font sizes. However, it is nonetheless advantageous to provide a systematic way to measure the reduction in quality.

In accordance with the illustrative embodiment of the present invention, an approach is employed which is based on a simple idea—since the receiver can always perform up-sampling, the distance between the down-sampled image and the original can be advantageously obtained by using the up-sampled image for comparison. Minimizing this measure immediately leads to an advantageous algorithm for down-sampling. The problem manifests itself as a structure-constrained optimization—that is, the pixels in an up-sampled block are constrained to be of the same color. Iterative optimization is still applicable. In fact, in accordance with another illustrative embodiment of the present invention, the framework of the above-described algorithm for color reduction can be easily extended by (1) initializing with a simple down-sampling operation, and (2) treating an up-sampled block as a unit and considering the change in the summed squared distance caused by a change in the color association for the unit. If there are no constraints on the number of output colors, Step 3 can be omitted.

For notational purposes, each region obtained through content-level analysis shall be referred to herein as an “object”. Thus, in accordance with the principles of the present invention, there are two relevant categories of objects—text and background. Note that the latter refers to the portion of the image with the text regions cropped out. An approximation for an object obtained through low-level analysis will be referred to herein as a “description”.

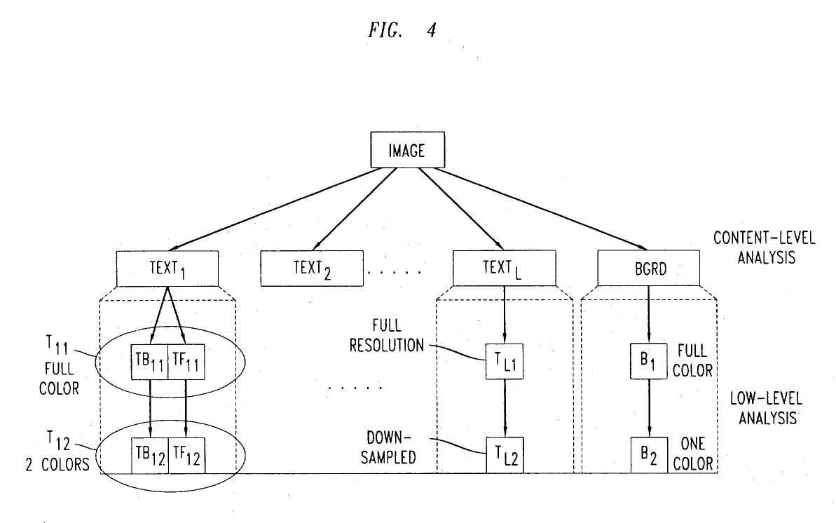

In accordance with the illustrative embodiment of the present invention, content-level and low-level image analysis advantageously facilitates a hierarchical decomposition of the image into a tree-structured representation. FIG. 4 shows an illustrative data structure representative of a web image in accordance with such an illustrative embodiment of the present invention.

Illustratively, referring to the figure, the web image first undergoes a content-level decomposition where the bounding boxes of text regions have been advantageously identified. The remainder of the image is then represented as a single node containing only the background (labeled “BGRD” in the figure). Each region is then further decomposed with low-level techniques. For example, a full-colored description for the text region of node “Text₁” is first given as T₁₁. Then, the foreground and the background (TF₁ and TB₁, respectively) can be identified and each advantageously represented with a single color. Thus, the text region is reduced to a binary image T₁₂. The text region of node “Text_{L}” is represented by a chain of reduced resolutions, with T_{L2} corresponding to a down-sampled version. The background region is represented by a chain of two nodes: B₁ corresponds to the full color representation, and B₂ corresponds to the single color version.

To save space, in accordance with the illustrative embodiment of the present invention, the tree-structured representation is advantageously encoded. Conceptually, compression here may merely comprise processing each description with a general-purpose algorithm such as the well-known Lempel-Zif '77 (LZ77) algorithm (which is fully familiar to those of ordinary skill in the art), and recording all of the structural information. However, in accordance with other illustrative embodiments of the present invention, correlations among the multiple descriptions may be advantageously taken into account.

To enable optimal content adaptation, rate-distortion information is advantageously collected. More specifically, the sizes of the LZ77 compressed nodes may be used for rate information. The quality measure defined in Equation (1) above illustratively serves as the distortion indicator. In order to achieve content-level quality evaluation, the feature space distortion measure may be further weighted for different objects (e.g., for text box or non-text regions). The weights can, for example, be assigned using heuristics and reflect relative importance. For example, for a small image such as a stylish navigation icon, the single color version of the background object can be assigned a very low distortion. Indeed, to save space, the full color version may be omitted entirely. The weight for an image with an associated hyperlink is advantageously set higher than for those without links. In general, the background object advantageously receives a lower weight than text boxes. Illustratively, a weight of 1.0 may be set for text boxes and a weight of 0.25 may be set for background objects.

Content Adaptation in an Illustrative Embodiment of the Invention

In accordance with the illustrative embodiment of the present invention, image analysis and compression are performed only once for each image. The resultant compact representations are then advantageously stored at a proxy server. Then, whenever a request is made for a web page, all images on the page are transcoded for efficient delivery to the particular small-screen device.

First, the available bandwidth can be advantageously estimated by monitoring the recent history of the link throughput. The simplest approach is to observe a time window and compute an average for the bandwidth based on this. Subtracting the bits reserved for other resources gives the overall bit budget for images on the web page, which will be denoted herein as B.

Recall that during the image analysis and compression stage, the rate-distortion information for all object descriptions has been advantageously collected. The optimization (i.e., transcoding) then seeks to find the best combination of descriptions within the bit budget constraints, illustratively based on the following mathematical analysis.

Assume that the objects in images for the current web page are numbered from 1 to I. Then, let B_{i,j}, i=1, . . . , I denote the j-th description for the i-th object; let Aᵢ be the associated original description, and let wᵢ be the weight for the i-th object. Denote the rate for B_{i,j} by R_{i,j}. Given a fixed bit budget B, the optimal selection of the object descriptions may be advantageously formulated as follows:

$${min}_{( j )} {\sum }_{i = 1}^{I} {w}_{i} \cdot {FD ( {A}_{i} , {B}_{i , j} )}^{2} subject to {\sum }_{i = 1}^{I} {R}_{i , j} \leq B . \qquad ( 3 )$$

As will be clear to one of ordinary skill in the art, Equation (3) can be solved exactly by well-known dynamic programming techniques, or, alternatively, the solution may be approximated by Lagrange multiplier techniques. (Both dynamic programming techniques and Lagrange multiplier techniques are fully familiar to those of ordinary skill in the art.)

In accordance with the illustrative embodiment of the present invention, after selecting the appropriate description for each image, the compressed bitstream is constructed. There are at least two possibilities for transcoding. If object-based decompression can be supported at the client device, the bitstream segments can simply be concatenated. This gives the decoder the flexibility to adapt the content locally according to user preferences. Otherwise, a standard format, such as, for example, PNG or GIF, should be used for the final output image. (PNG and GIF are well known conventional image formatting standards, fully familiar to those of ordinary skill in the art.) Since this option requires no modification in the client, it is easy to deploy.

Different algorithms may be used in accordance with various embodiments of the present invention to compose the selected descriptions for a given image to form the output. One (simplistic) illustrative approach would be to: (1) decompress the selected description for each individual object, (2) compose these into one image, and (3) re-compress the composite image. Other illustrative approaches may be employed to take advantage of the already-compressed bitstream segments to facilitate the creation of the final compressed stream. In other words, it is possible to perform compression using prior information. Some such techniques will be obvious to those skilled in the art.

A Flexible Interactive Display in an Illustrative Embodiment of the Invention

The decoder and rendering system are ideal places to incorporate user preferences and interaction as the communication overhead is minimal. Since screen space and memory may be assumed to be limited, only images currently being displayed or likely to be viewed in the near future are advantageously decompressed in accordance with the illustrative embodiment of the present invention. The layout of the modified web page may also be arranged by the rendering system based on user feedback.

Note that with the above-described transmission scheme, it is likely that certain images contain blank regions. To use the display space economically, the user may advantageously set the rendering system to automatically detect the blank regions and use the space for other more important information. Alternatively, he or she may click on these regions to remove them manually.

Addendum to the Detailed Description

It should be noted that all of the preceding discussion merely illustrates the general principles of the invention. It will be appreciated that those skilled in the art will be able to devise various other arrangements, which, although not explicitly described or shown herein, embody the principles of the invention, and are included within its spirit and scope.

Furthermore, all examples and conditional language recited herein are principally intended expressly to be only for pedagogical purposes to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. It is also intended that such equivalents include both currently known equivalents as well as equivalents developed in the future—i.e., any elements developed that perform the same function, regardless of structure.

Thus, for example, it will be appreciated by those skilled in the art that the block diagrams herein represent conceptual views of illustrative circuitry embodying the principles of the invention. Similarly, it will be appreciated that any flow charts, flow diagrams, state transition diagrams, pseudocode, and the like represent various processes which may be substantially represented in computer readable medium and so executed by a computer or processor, whether or not such computer or processor is explicitly shown. Thus, the blocks shown, for example, in such flowcharts may be understood as potentially representing physical elements, which may, for example, be expressed in the instant claims as means for specifying particular functions such as are described in the flowchart blocks. Moreover, such flowchart blocks may also be understood as representing physical signals or stored physical data, which may, for example, be comprised in such aforementioned computer readable medium such as disc or semiconductor storage devices.

The functions of the various elements shown in the figures, including functional blocks labeled as “processors” or “modules” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read-only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

We claim:

1. A method for coding a web image for use in a client device having a display, the method comprising the steps of:
identifying in said web image one or more text-containing regions thereof as comprising textual information therein, and one or more non-text-containing regions thereof as not comprising textual information therein;
differentially transcoding said one or more text-containing regions and said one or more non-text-containing regions, said one or more text-containing regions and said one or more non-text-containing regions being transcoded so as to result in an improved image quality of said one or more text-containing regions relative to said one or more non-text-containing regions, said transcoding based on one or more characteristics of said display of said client device.

2. The method of claim 1 further comprising the step of transmitting said coding of said web image to said client device with use of a communications channel.

3. The method of claim 2 wherein said transcoding is further based on one or more characteristics of said communications channel.

4. The method of claim 3 wherein said one or more characteristics of said communications channel comprises a bandwidth thereof.

5. The method of claim 1 wherein said one or more characteristics of said display of said client device comprises a display resolution thereof.

6. The method of claim 5 wherein said differential transcoding comprises down-sampling said one or more non-text-containing regions.

7. The method of claim 1 wherein said one or more characteristics of said display of said client device comprises a color depth thereof.

8. The method of claim 7 wherein said differential transcoding comprises performing color reduction on said one or more non-text-containing regions.

9. The method of claim 1 wherein said one or more characteristics of said display of said client device comprises a number of gray levels thereof.

10. The method of claim 9 wherein said differential transcoding comprises reducing a number of gray levels of said one or more non-text-containing regions.

11. A method for generating a data structure representing a web image, the method comprising the steps of:
identifying in said web image a plurality of regions thereof, one or more of said regions comprising textual information therein and identified as text-containing regions thereof, and one or more of said regions not comprising textual information therein and identified as non-text-containing regions thereof; and
generating a plurality of coded representations of each of said plurality of non-text-containing regions, each of said plurality of coded representations of a given one of said non-text-containing regions comprising a different transcoding thereof.

12. The method of claim 11 further comprising the step of generating a plurality of coded representations of each of said plurality of text-containing regions, each of said plurality of coded representations of a given one of said text-containing regions comprising a different transcoding thereof.

13. The method of claim 11 wherein one or more of said different transcodings of at least one of said non-text-containing regions includes a transcoding which comprises down-sampling thereof.

14. The method of claim 11 wherein one or more of said different transcodings of at least one of said non-text-containing regions includes a transcoding which comprises performing color reduction thereon.

15. The method of claim 11 wherein one or more of said different transcodings of at least one of said non-text-containing regions includes a transcoding which comprises reducing a number of gray levels thereof.

16. A computer-readable medium comprising a data structure representing a web image, the data structure comprising:
one or more coded representations of each of one or more text-containing regions in said web image, each of said text-containing regions comprising textual information therein; and
a plurality of coded representations of each of one or more non-text-containing regions in said web image, each of said non-text-containing regions not comprising textual information therein, each of said plurality of coded representations of a given one of said non-text-containing regions comprising a different transcoding of said given one of said non-text-containing regions.

17. The computer-readable medium of claim 16 wherein said computer-readable medium comprises a computer memory device.

18. The computer-readable medium of claim 16 wherein said one or more coded representations of each of one or more text-containing regions comprises a plurality of said coded representations of coded representations of each of one or more text-containing regions, and wherein each of said plurality of coded representations of a given one of said text-containing regions comprises a different transcoding of said given one of said text-containing regions.

19. The computer-readable medium of claim 16 wherein one or more of said different transcodings of at least one of said non-text-containing regions includes a transcoding which comprises down-sampling thereof.

20. The computer-readable medium of claim 16 wherein one or more of said different transcodings of at least one of said non-text-containing regions includes a transcoding which comprises performing color reduction thereon.

21. The computer-readable medium of claim 16 wherein one or more of said different transcodings of at least one of said non-text-containing regions includes a transcoding which comprises reducing a number of gray levels thereof.

22. A server in a computer network, the server comprising:
a computer memory device comprising a data structure representing a web image for use in a client device having a display, the data structure comprising
(a) one or more coded representations of each of one or more text-containing regions in said web image, each of said text-containing regions comprising textual information therein, and
(b) a plurality of coded representations of each of one or more non-text-containing regions in said web image, each of said non-text-containing regions not comprising textual information therein, each of said plurality of coded representations of a given one of said non-text-containing regions comprising a different transcoding of said given one of said non-text-containing regions; and
a processor adapted to generate a coding of said web image by selecting
(i) one of said coded representations of each of said one or more text-containing regions, and
(ii) one of said coded representations of each of said one or more non-text-containing regions,
wherein said selections of said coded representations results in an improved image quality of said text-containing regions relative to said non-text-containing regions, and wherein said selections are based on one or more characteristics of said display of said client device.

23. The server of claim 22 wherein said processor is further adapted to transmit said coding of said web image to said client device with use of a communications channel, and wherein said selections of said coded representations are further based on one or more characteristics of said communications channel.

24. The server of claim 22 wherein one or more of said different transcodings of at least one of said non-text-containing regions includes a transcoding which comprises down-sampling thereof.

25. The server of claim 22 wherein one or more of said different transcodings of at least one of said non-text-containing regions includes a transcoding which comprises performing color reduction thereon.

26. The server of claim 22 wherein one or more of said different transcodings of at least one of said non-text-containing regions includes a transcoding which comprises reducing a number of gray levels thereof.
